(19) United States
(12) Patent Application Publication
(10) Pub. No.: US 2011/0060566 A1
(43) Pub. Date: Mar. 10, 2011

(54) METHOD AND APPARATUS FOR SCATTER CORRECTION

(75) Inventors: Matthias Bertram, Aachen (DE); Jens Wiegert, Aachen (DE); Steffen Gunther Hohmann, Koln (DE)

(73) Assignee: KONINKLIJKE PHILIPS ELECTRONICS N.V., EINDHOVEN (NL)

(21) Appl. No.: 12/991,708

(22) PCT Filed: May 13, 2009
(86) PCT No.: PCT/IB09/51988

§ 371 Date: Nov. 9, 2010

Related U.S. Application Data
(60) Provisional application No. 61/054,825, filed on May 21, 2008.

(51) Int. Cl. G06F 17/10

(52) U.S. Cl. 703/2

(57) ABSTRACT

A method and apparatus of image reconstruction correcting for photon scatter is provided. A direct physical measurement of scattered photons is used in conjunction with a physical model of the photon scattering process to make the corrections.

The present application relates generally to the imaging arts and more particularly to an apparatus and method for scattered photon correction. It finds use in X-ray imaging (using X-ray photons), Computer Tomography or CT imaging (using X-ray photons), and other kinds of systems such as image-guided radiation therapy systems.

Such imaging processes generally include a radiation source which produces imaging photons. The photons pass through the imaged subject to be collected or counted by a photon detector. Data generated by the photon detector is then electronically processed to generate an image of the subject. Two types of photons reach the photon detector. The first are “primary” photons, which are generated by the photon source and travel on a straight line path through the imaged subject to reach the photon detector. The second are “scattered” photons, including photons which are generated by the photon source but which get redirected off of a straight line path during their travel to the photon detector, and also including extraneous background photons which were not actually generated by the photon source. Scattered photons can introduce error into the image reconstruction process. Therefore, to generate highly accurate images of the subject, data generated by the photon detector as a result of scattered photons is typically discounted or corrected for during the image reconstruction process.

According to one aspect of the present invention, a method and apparatus are provided for improved photon scatter correction.

According to a particular aspect of the present invention, an imaging method is provided. A direct physical measurement of scattered photons, as well as a model of the photon scattering process, are used in conjunction during image reconstruction to correct for photon scatter in generating an image. This method may additionally provide a correction for low frequency drop.

According to another aspect of the present invention, an imaging apparatus is provided. The imaging apparatus has a photon source and a photon detector. The photon detector has two regions. A first, imaging region of the photon detector receives photons traveling along flight paths leading on a straight line path back to the photon source. A second, scatter region of the photon detector is closed to such photons by a shutter, but is open to other photons. The measurement of scattered photons received by the second, scatter region of the photon detector may then be used in conjunction with a model of the photon scattering process during image reconstruction to correct for scattered photons in the imaging data collected from the first, imaging region of the photon detector.

One advantage resides in a more accurate and robust scatter correction, reducing the risk of visible scatter artifacts appearing in images. Another advantage resides in producing more useful X-ray, CT, PET, SPECT or other images. Numerous additional advantages and benefits will become apparent to those of ordinary skill in the art upon reading the following detailed description of preferred embodiments.

The invention may take form in various components and arrangements of components, and in various process operations and arrangements of process operations. The drawings are only for the purpose of illustrating preferred embodiments and are not to be construed as limiting the invention.

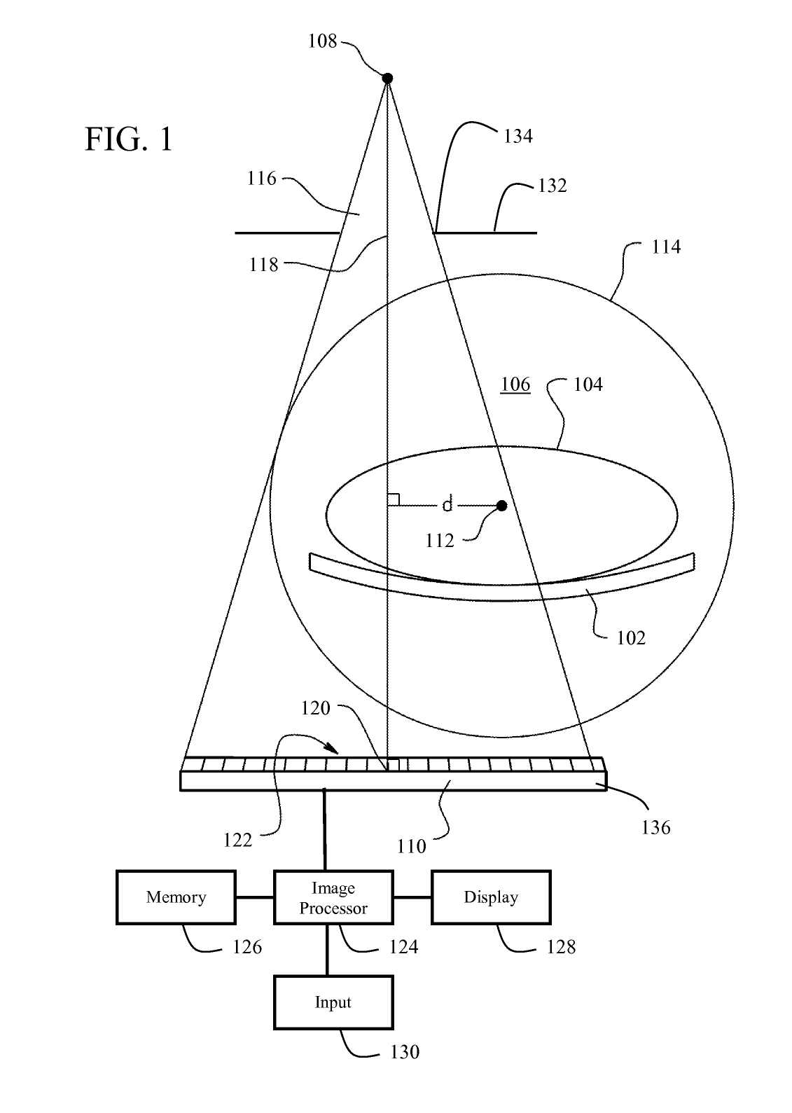

FIG. 1 is a schematic representation of an imaging system;

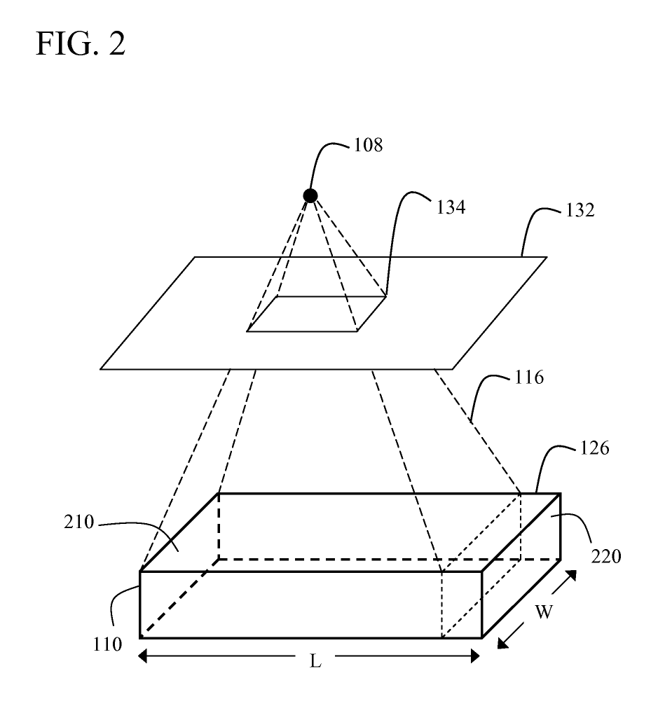

FIG. 2 schematically illustrates the X-ray detector and shutter used in the imaging system of FIG. 1;

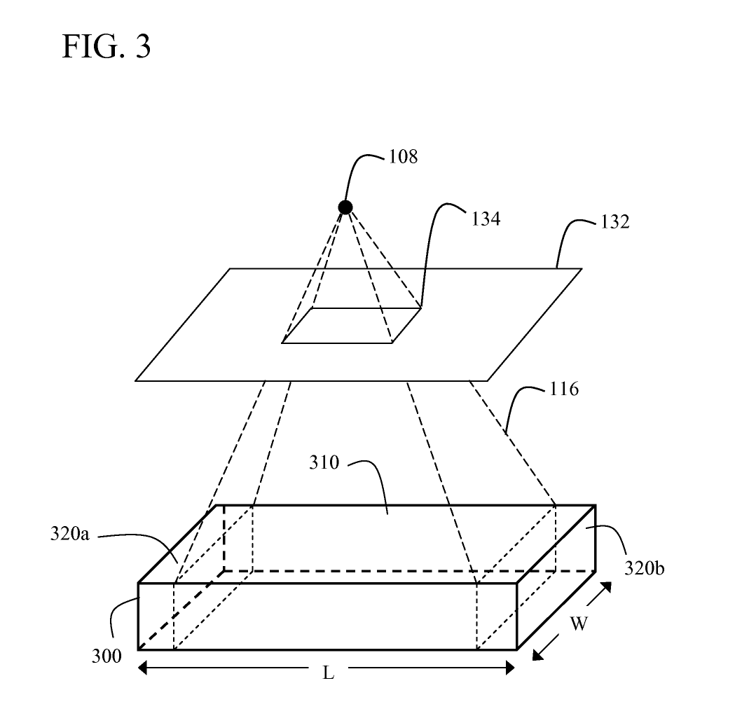

FIG. 3 schematically illustrates an alternative X-ray detector and shutter combination;

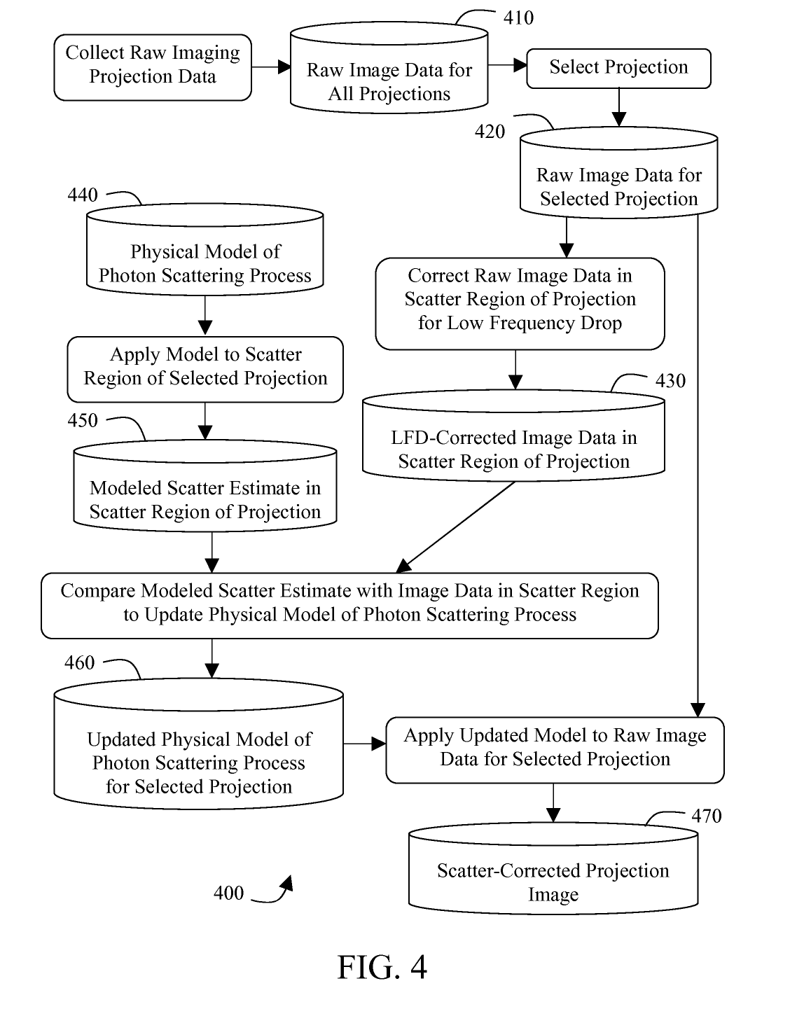

FIG. 4 illustrates a process to correct for scattered photons in generating images;

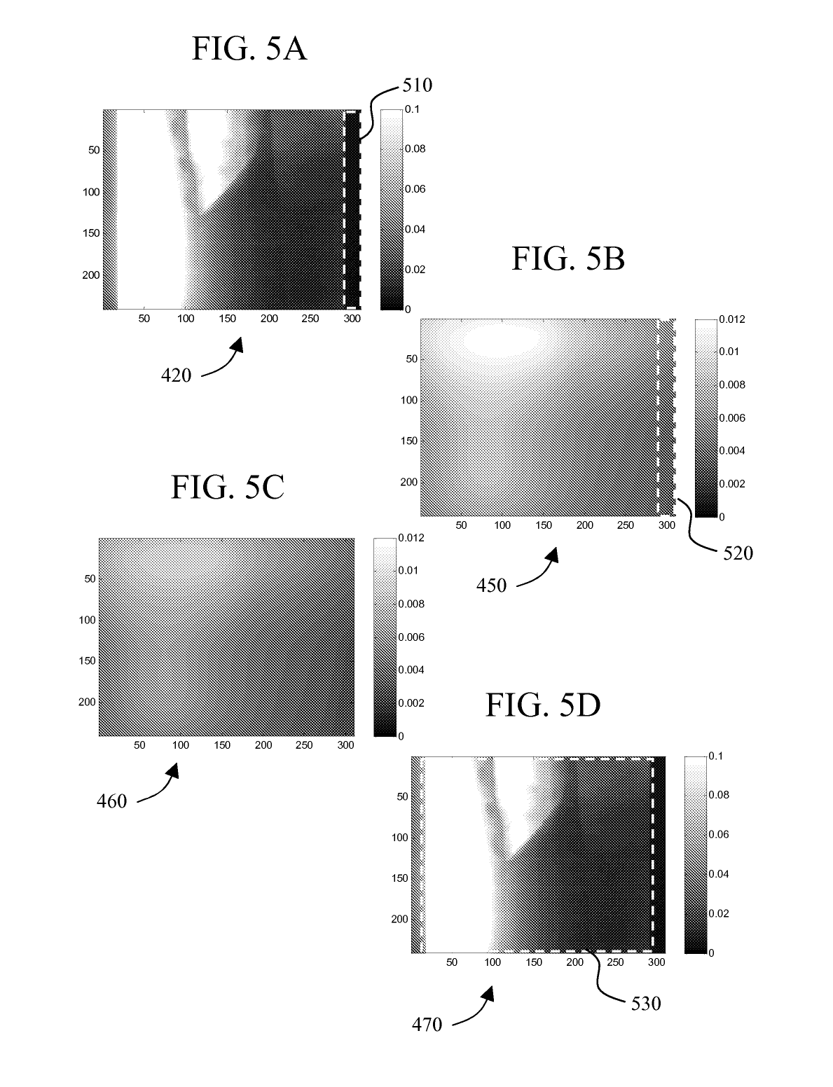

FIGS. 5A to 5D are representative images which may be used in association with the process of FIG. 4.

The imaging method and apparatus of the present application are directed generally to any imaging system which corrects for scattered photons. One example of such an apparatus is the imaging system 100 shown in FIG. 1, which is particularly useful in generating CT images. As already mentioned, the imaging method and apparatus disclosed here have application in various other kinds of imaging systems.

As illustrated in FIG. 1, a couch or other suitable object support 102 supports an object under examination 104 in an examination region 106. An X-ray source 108 such as an X-ray tube, and an X-ray detector 110 such as a flat panel area detector, are provided. The X-ray source 108 and X-ray detector 110 are mounted on a common rotating gantry (not shown) having a center of rotation 112. The X-ray source 108 and X-ray detector 110 together rotate with the gantry around the support 102 and the imaged subject 104. In that way, imaging measurements may be taken of the transverse field of view (FOV) 114, the center of which corresponds to the center of rotation 112. The X-ray beam 116 generated by the X-ray source 108 has a central ray or projection 118 which is perpendicular to the transverse center 120 of the X-ray detector 110 and is displaced from the center of rotation 112 by a distance d. If d is greater than 0, as shown for example in FIG. 1, then the X-ray detector 110 is in an “offset” configuration. If d equals 0, then the central ray 118 passes through the center of rotation 112, and the X-ray detector 110 is in a “central” configuration.

A collimator 122 is mounted proximate to the X-ray detector 110, between the detector 110 and the examination region 106, to reduce the amount of scattered photons received by the detector 110. In general, collimators operate to filter the streams of incoming photons so that only photons traveling in a specified direction are allowed through the collimator. Which direction(s) are permitted through which portion(s) of the collimator is determined in accordance with the data type being collected (for example, whether the X-ray source 108 or other photon source is configured to produce a parallel beam, fan beam, and/or cone beam). The collimator 122 shown in FIG. 1 includes a plurality of lamellae focused on the X-ray source 108. If the X-ray source 108 is a line source extending generally parallel to the rotation axis 112, then the X-ray beam 116 will be a “fan beam.” In that event, the lamellae of the collimator 122 will be transversely symmetric with respect to the transverse center 120 of the detector 110. If the X-ray source 108 is a point source, then the X-ray beam 116 will be a “cone beam.” In that event, the lamellae of the collimator 122 will vary in both the transverse and axial directions to point back to the point source.

The X-ray detector 110 may include, for example, a scintillator that emits a secondary flash of light or photons in response to the incident X-ray photons 116, or optionally can be a solid state direct conversion material (e.g. CZT). In the former instance, an array of photomultiplier tubes or other suitable photodetectors in the detector 110 receives the secondary light and converts it into electrical signals. The X-ray detector 110 records multiple two dimensional images (also called projections) at different points around the imaged subject 104. That X-ray projection data is stored by an imaging data processor 124 in a memory 126. Once all the X-ray projection data is gathered, it may be electronically processed by the imaging data processor 124. The processor 124 generates an image of the subject 104, according to a mathematical algorithm or algorithms, which can be displayed on an associated display 128. A user input 130 may be provided for a user to control the processor 124.

The aforementioned functions can be performed as software logic. “Logic,” as used herein, includes but is not limited to hardware, firmware, software and/or combinations of each to perform a function(s) or an action(s), and/or to cause a function or action from another component. For example, based on a desired application or needs, logic may include a software controlled microprocessor, discrete logic such as an application specific integrated circuit (ASIC), or other programmed logic device. Logic may also be fully embodied as software.

“Software,” as used herein, includes but is not limited to one or more computer readable and/or executable instructions that cause a computer or other electronic device to perform functions, actions, and/or behave in a desired manner. The instructions may be embodied in various forms such as routines, algorithms, modules or programs including separate applications or code from dynamically linked libraries. Software may also be implemented in various forms such as a stand-alone program, a function call, a servlet, an applet, instructions stored in a memory such as memory 126, part of an operating system or other type of executable instructions. It will be appreciated by one of ordinary skill in the art that the form of software is dependent on, for example, requirements of a desired application, the environment it runs on, and/or the desires of a designer/programmer or the like.

The systems and methods described herein can be implemented on a variety of platforms including, for example, networked control systems and stand-alone control systems. Additionally, the logic, databases or tables shown and described herein preferably reside in or on a computer readable medium such as the memory 126. Examples of different computer readable media include Flash Memory, Read-Only Memory (ROM), Random-Access Memory (RAM), programmable read-only memory (PROM), electrically programmable read-only memory (EPROM), electrically erasable programmable read-only memory (EEPROM), magnetic disk or tape, optically readable mediums including CD-ROM and DVD-ROM, and others. Still further, the processes and logic described herein can be merged into one large process flow or divided into many sub-process flows. The order in which the process flows herein have been described is not critical and can be rearranged while still accomplishing the same results. Indeed, the process flows described herein may be rearranged, consolidated, and/or re-organized in their implementation as warranted or desired.

As already discussed, the collected projection data generally contains inaccuracies caused by scattered X-rays. The imaging system 100 geometry shown in FIG. 1 can be highly susceptible to X-ray scattering, for at least two reasons. First, the X-ray detector 110 is offset from the X-ray source 108 by a distance d which is greater than zero. Second, the X-ray source 108 emits X-rays in a cone-beam configuration. The X-ray scattering of such a configuration, and other configurations, may be corrected for as follows.

A mathematical algorithm is applied to the projection data collected by the X-ray detector 110 to correct for X-ray scatter and generate sufficiently accurate CT images. That mathematical algorithm applies a model of photon scattering. The model may be a physical model, based on assumptions or estimates regarding the physical space between the X-ray source 108 and the X-ray detector 110, including the subject 104. One such algorithm is disclosed in PCT Application Publication WO 2007/148263 entitled “Method and System for Error Compensation.” That application is incorporated herein by reference for its disclosure of photon scatter compensation based on a physical model. Other algorithms may be used to correct for photon scatter, including the disclosures of:
J. Wiegert, M. Bertram, G. Rose and T. Aach, “Model Based Scatter Correction for Cone-Beam Computed Tomography”, Medical Imaging 2005: Physics of Medical Imaging, Proceedings of SPIE Vol. 5745 (2005), at 271-82;
J. Wiegert, M. Bertram, D. Schafer, N. Noordhoek, K. de Jong, T. Ach and G. Rose, “Soft Tissue Contrast Resolution Within the Head of Human Cadaver by Means of Flat Detector Based Cone-Beam CT”, Medical Imaging 2004: Physics of Medical Imaging, Proceedings of SPIE Vol. 5368 (2004), at 330-37;
M. Bertram, J. Wiegert and G. Rose, “Scatter Correction for Cone-Beam Computed Tomography Using Simulated Object Models”, Medical Imaging 2006: Physics of Medical Imaging, Proceedings of SPIE Vol. 6142 (2006), at C-1 to C-12.
L. A. Love and R. Kruger, “Scatter Estimation for a Digital Radiographic System Using Convolution Filtering”, Med. Phys. Vol. 14, No. 2 (March/April 1987), at 178-85;
B. Ohnesorge, T. Flohr and K. Klingenbeck-Regn, “Efficient Object Scatter Correction Algorithm for Third and Fourth Generation CT Scanners”, Eur. Radiol. Vol. 9 (1999), at 563-69;
M. Zellerhoff, B. Scholz, E. P. Rührnschopf and T. Brunner, “Low Contrast 3D-Reconstruction from C-Arm Data”, Medical Imaging 2005: Physics of Medical Imaging, Proceedings of SPIE Vol. 5745 (2005), at 646-55;
V. Hansen, W. Swindell and P. Evans, “Extraction of Primary Signal from EPIDs Using Only Forward Convolution”, Med. Phys. Vol. 24, No. 2 (September 1997), at 1477-84;
J. Seibert and J. Boone, “X-Ray Scatter Removal by Deconvolution”, Med. Phys. Vol. 15, No. 4 (July/August 1988), at 567-75; and
L. Spies, M. Ebert, B. Groh, B. Hesse and T. Bortfeld, “Correction of Scatter in Megavoltage Cone-Beam CT”, Phys. Med. Biol. Vol. 46 (2001), at 821-33.

Those sources are hereby incorporated by reference for their respective disclosures of photon scatter correction models and algorithms. Such models and algorithms may be applied using the processor 124 and memory 126 described above.

Such scatter correction models and algorithms may be used in conjunction with a direct physical measurement of scattered photons. For example, as shown in FIG. 1, a shutter mechanism 132 may be disposed between the X-ray source 108 and the examination subject 104. The shutter mechanism 132 operates to block the X-ray beam 116 except for an aperture 134 provided in the shutter mechanism 132. The size of the aperture 134 may be adjustable. In the configuration illustrated in FIG. 1, the shutter mechanism 132 prevents the X-ray beam 116 from reaching a lateral border 136 of the X-ray detector 110. That border 136 is positioned approximately behind the center of the imaged subject 104 and near the center of rotation 112.

Turning now to FIG. 2, the X-ray detector 110 of FIG. 1 is shown with the shutter mechanism 132. The collimator 122 is not shown in FIG. 2. The X-ray detector 110 is divided into two regions: an imaging region 210 and a scatter region 220. The imaging region 210 of the X-ray detector 110 corresponds to the aperture 134 in the shutter mechanism 132, so it receives photons traveling along flight paths leading on a straight line path back to the X-ray source 108. In other words, the imaging region 210 is open to primary photons as well as to scattered photons which approach the collimator 122 and detector 110 along the same flight paths as primary photons. The shutter mechanism 134 prevents the scatter region 220 of the X-ray detector 110 from receiving primary photons, but the scatter portion 220 is open to other photons. Thus, the scatter region 220 is open to scattered photons but not to primary photons.

There is not necessarily any difference in structure or operation of the X-ray detector 110 in the imaging region 210 and the scatter region 220. Rather, the imaging region 210 of the X-ray detector 110 will count primary photons as well as scattered photons which approach the X-ray detector 110 along the same flight path as primary photons. And the scattered region 220 of the X-ray detector 110 will count scattered photons, but not primary photons. Of course, alternatively the X-ray detector 110 may be two separate X-ray detectors with one in each region 210, 220.

As shown in FIG. 2, the scatter region 220 of the X-ray detector 110 is one contiguous region of the detector 110, extending across the entire width W and a portion of the length L. When the detector 110 is placed in the imaging system 100, the scatter region 220 may be advantageously positioned approximately behind the center of the imaged subject 104 and near the center of rotation 112 along the lateral border 126, as illustrated in FIG. 1.

The scatter region of the X-ray detector need not be entirely contiguous like the representative scatter region 220 shown in FIG. 2. For example, FIG. 3 shows an X-ray detector 300 having an imaging region 310 and a scatter region 320 including two non-contiguous sub-portions 320a and 320b. The sub-portions 320a, 320b are disposed at opposing lateral borders of the detector 300. This configuration is especially useful for an X-ray detector 300 meant for use in a CT apparatus with a center detector arrangement, such as for example a C-arm arrangement. Any number of non-contiguous sub-portions may be used to form a scatter portion in a photon detector.

Yet other configurations are of course possible. The scatter region of the photon detector may be located along the entire border of the detector (e.g., all four sides of a rectangular detector). Or it may be a polka dot pattern, for example. The amount of overall detector area devoted to the scatter region should optionally be large enough to help compensate for low frequency drop or LFD (discussed further below) yet small enough to leave a sufficiently large area remaining for the imaging region to generate a useful image. It has been found that, in a rectangular detector 110 such as shown in FIG. 2 wherein L equals about 38 cm and W equals about 29 cm, a scatter region 220 extending along the entire width and about 2 cm of the length is sufficient.

The direct physical measurement of scattered photons striking the scatter region of the photon detector may be used during image reconstruction to correct for scattered photons in the imaging data recorded in the imaging region of the photon detector. Generally, the scatter region of the photon detector collects substantially only scattered photons. The scatter region of the photon detector then generates an electronic signal reflecting only such scattered photons. The direct physical measurement of scattered photons may be used to estimate the contribution of scattered photons to other areas of the photon detector. That estimate may then be subtracted or divided from the signal produced by the photon detector in those areas to correct for scattered photons and generate a more accurate image.

For example, such a process 400 is shown in FIGS. 4 and 5A to 5D. Initially, as shown in FIG. 4, raw image data 410 is collected by rotating the X-ray source 108 and X-ray detector 110 with the collimator 122 around the imaged subject 104. The data 410 is a collection of several two-dimensional projection images recorded by the X-ray detector 110 at various imaging positions disposed around the subject 104. One of those projections is then selected to undergo the process 400 to correct the selected projection's imaging data 420 for scatter. Once all such projections have been corrected for scatter, the projections are then processed together as a whole to generate a final image.

Often, a single projection image 420 may initially be corrected for low frequency drop (LFD) within the X-ray detector 110 to obtain an LFD-corrected projection image 430. LFD results from photons scattering within the scintillator component of the X-ray detector 110. LFD can strongly falsify the signals recorded by the X-ray detector 110, especially portions of the detector nearby large incident X-ray intensity. Although LFD corrections may be made in the imaging region 210 and in the scatter region 220 of the X-ray detector 110, they are especially useful in the scatter region 220 due to the relatively low amounts of photons in that region 220. Thus, it is typically advantageous to place the scatter region 220 in an area of the X-ray detector 110 which is sufficiently far from areas with high incident X-ray intensity. Using the geometry shown in FIG. 1, that condition is usually met for the lateral border 126 of the X-ray detector 110 positioned approximately behind the center of the imaged subject 104 and near the center of rotation 112. That border 126 is subject to a relatively low intensity of X-rays because it lies in the shadow of the object support 102 and/or the object 104. Thus, the X-ray detector 110 of FIG. 2 is particularly useful in connection with the imaging system 100 of FIG. 1 if the scatter region 220 lies along the border 126. Other configurations will be better suited for use in connection with other imaging system geometries. For example, the X-ray detector 300 of FIG. 3 can be well suited for use in connection with a center detector arrangement such as for example a C-arm arrangement.

FIG. 5A shows a representative projection image 420 or 430, taken using a CT system having the geometry of the system 100 and using a shutter 132 and X-ray detector 110. The dotted region 510 in the image 420 or 430 corresponds to the scatter region 220 of the X-ray detector 110 used to generate the image 420 or 430.

Once a raw image is selected 420, and LFD corrections have been made to that image (if desired), then a physical or empirical model of the photon scattering process 440 is employed. Representative examples of such a physical model are provided above. Such a physical model 440 advantageously covers at least a portion of the imaging region 210 and at least a portion of the scatter region 220 of the X-ray detector 110. Using the physical model 440, a scatter estimate 450 corresponding to the scatter region 220 is calculated for the projection 420 or 430. FIG. 5B shows a representative example of such a scatter estimate 450, generated using the physical model of WO 2007/148263. The modeled scatter estimate 450 corresponding to the scatter region 220 for the selected projection 420 (e.g., dotted region 520 in FIG. 5B) is then compared with the measured data 420 or 430 from the scatter region 220 for the selected projection 420 (e.g., dotted region 510 in FIG. 5A).

Based on that comparison, the scatter model 440 is globally adjusted over the entire X-ray detector region 210 and 220 to obtain an updated physical scatter model 460. This adjustment is made in such a way that maximum correspondence is obtained in the scatter region 220 between the updated physical scatter model 460 and the measured data 420 or LFD-corrected data 430. This may be achieved, for example, by multiplying the initial scatter estimate 450 with a scaling factor that is chosen in such a way so as to minimize the root mean square difference between the scatter estimate 450 and the measured data 420 or 430 in the scatter region 220. The scaling factors may be weighted to rely more heavily on portions of the region 220 which are believed to be more accurate than other portions. FIG. 5C shows a representative example of an updated scatter model 460, based on the same imaging data used to generate FIGS. 5A and 5B.

Once the improved scatter model 460 is calculated for a particular projection 420 or 430, that improved model 460 is applied to the imaging projection data 420 or 430 to correct for scattered photons and generate a scatter-corrected projection image 470. This correction may be carried out, for example, in a subtractive or a multiplicative manner. FIG. 5D shows a representative example of such a scatter-corrected projection image 470. The dotted region 530 in the image 470 corresponds to the imaging region 210 of the X-ray detector 110. It is the scatter-corrected data corresponding to that region 210 which is later used by the image processor 124 to generate an image of the subject 104.

Once all the projections in the data acquisition have been adjusted according to the process 400 of FIG. 4, the scatter-corrected projections 470 are reconstructed together to obtain a tomographic image of the scanned subject 104, as will be well understood by one of ordinary skill in this art.

While the present scatter correction technique is particularly useful in a cone-beam CT apparatus with an offset detector as shown in FIG. 1, it has application in other contexts as well. For example, it may be employed to correct for scatter photons in a cone-beam CT apparatus with a centered detector, such as for example C-arms.

The invention has been described with reference to the preferred embodiments. Obviously, modifications and alterations will occur to others upon reading and understanding the preceding detailed description. It is intended that the invention be construed as including all such modifications and alterations insofar as they come within the scope of the appended claims or the equivalents thereof. The invention may take form in various components and arrangements of components, and in various steps and arrangements of steps. The drawings are only for purposes of illustrating the preferred embodiments and are not to be construed as limiting the invention.

1. A method of correcting for photon scatter, the method comprising:
using a photon source to generate photons which pass through a subject to be imaged;
moving a photon detector to multiple imaging positions around the subject to record an image projection at each imaging position, wherein each image projection comprises a scatter region exposed substantially only to scatter photons and an imaging region exposed to primary photons and scatter photons;
correcting at least a portion of each image projection for low frequency drop;
applying, for each imaging position, a model of a photon scattering process to produce an estimate of the exposure of the scatter region scatter photons;
comparing the scatter region of each image projection with the estimate of the exposure of the scatter region to scatter photons;
based at least in part on the comparison, modifying the model to generate an updated model of the photon scattering process; and
applying the updated model to the imaging region of each image projection to generate a scatter-corrected image projection.

2. The method of claim 1, wherein a shutter is used to segregate the scatter region from the imaging region.

3. The method of claim 2 wherein the shutter is disposed between the photon source and the subject.

4. The method of claim 2, wherein the scatter region comprises an elongated area disposed along one or more borders of the photon detector.

5. The method of claim 2, wherein the scatter region comprises at least two non-contiguous sub-portions.

6. The method of claim 1, wherein at least the scatter region of the image projection is corrected to compensate for low frequency drop.

7. The method of claim 1, wherein the photon detector is in an offset configuration.

8. The method of claim 1, wherein the model is a physical model based on assumptions or estimations regarding the physical space traversed by photons before they reach the photon detector.

9. The method of claim 1, wherein the image projections are further processed to generate a tomographic image of the subject.

10. The method of claim 1, wherein the photon detector is in an offset configuration, and the scatter region is disposed along a border of the photon detector in the shadow of the subject).

11. An apparatus for correcting for photon scatter, the apparatus comprising:
a photon source for generating photons which pass through a subject to be imaged in an imaging area;
a photon detector moveable between multiple imaging positions around the imaging area to record an image projection at each imaging position, the photon detector comprising a scatter region exposed substantially only to scatter photons to generate a scatter region signal and an imaging region exposed to primary photons and scatter photons to generate an imaging region signal; and
an image processor which:
receives the scatter region signal from the photon detector;
corrects at least a portion of the scatter region signal or the imaging region signal for low frequency drop;
uses a model of a photon scattering process to produce a scatter exposure estimate of the exposure of the scatter region to scatter photons;
compares the scatter region signal to the scatter exposure estimate;
based at least in part on the comparison, generates an updated model of the photon scattering process; and
applies the updated model to the imaging region signal to generate a scatter-corrected image projection; and
a display for a user to view images of the subject.

12. The apparatus of claim 11 further comprising a shutter used to segregate the scatter region from the imaging region.

13. The apparatus of claim 12 wherein the shutter is disposed between the photon source and the subject.

14. The apparatus of claim 12, wherein the scatter region comprises an elongated area disposed along one or more borders of the photon detector.

15. The apparatus of claim 12, wherein the scatter region comprises at least two non-contiguous sub-portions.

16. The apparatus of claim 11, wherein at least the scatter region signal is corrected to compensate for low frequency drop.

17. The apparatus of claim 11, wherein the photon detector is in an offset configuration.

18. The apparatus of claim 11, wherein the model is a physical model based on assumptions or estimations regarding the physical space traversed by photons before they reach the photon detector.

19. The method of claim 11, wherein the photon detector is in an offset configuration, and the scatter region is disposed along a border of the photon detector in the shadow of the subject.

20. A method of correcting for photon scatter in an image, the method comprising:
using a photon source to generate photons which pass through a subject to be imaged;
using a photon detector to record an image of the subject wherein the image comprises a scatter region exposed substantially only to scatter photons and an imaging region exposed to primary photons and scatter photons;
correcting at least a portion of the image for low frequency drop;
applying a model of a photon scattering process to produce an estimate of the exposure of the scatter region to scatter photons;
comparing the scatter region of the image with the estimate of the exposure of the scatter region to scatter photons;
based at least in part on the comparison, modifying the model to generate an updated model of the photon scattering process; and
applying the updated model to the imaging region of the image to generate a scatter-corrected.

21. The method of claim 20, wherein a shutter is used to segregate the scatter region from the imaging region.

22. The method of claim 20, wherein at least the scatter region of the image is corrected to compensate for low frequency drop.

23. The method of claim 20, wherein the photon detector is in an offset configuration, and the scatter region is disposed along a border of the photon detector in the shadow of the subject.

24. A computer readable medium including one or more computer executable instructions for correcting an image for photon scatter, the computer readable medium comprising:
logic for receiving an image signal from a photon detector, wherein the image signal comprises a scatter region signal from a scatter region of the photon detector which is exposed substantially only to scatter photons, and an imaging region signal from an imaging region of the photon detector which is exposed to primary photons and scatter photons;
logic for correcting at least a portion of the image signal for low frequency drop;
logic which applies a model of a photon scattering process to produce an estimate of the scatter region signal;
logic which compares the scatter region signal received from the photon detector with the estimate of the scatter region signal;
logic which, based at least in part on the comparison, modifies the model to generate an updated model of the photon scattering process; and
logic which applies the updated model to the imaging region signal to generate a scatter-corrected image.
